(19) United States
(12) Patent Application Publication
(10) Pub. No.: US 2024/0382790 A1
(43) Pub. Date: Nov. 21, 2024

(54) PORTABLE MISTING WATER-BASED FIRE EXTINGUISHER

(71) Applicant: Pyronemesis, Inc., Longmont, CO (US)

(72) Inventor: Stephen Wolf, Longmont, CO (US)

(73) Assignee: Pyronemesis, Inc., Longmont, CO (US)

(21) Appl. No.: 18/692,599

(22) PCT Filed: Sep. 15, 2022
(86) PCT No.: PCT/US2022/076451

§ 371 Date: Mar. 15, 2024

Related U.S. Application Data
(60) Provisional application No. 63/245,689, filed on Sep. 17, 2021.

(51) Int. Cl. A62C 25/00; A62C 15/00

(52) U.S. Cl. CPC A62C 25/00; A62C 15/00

(57) ABSTRACT

Described are portable fire extinguishing systems for efficient and rapid fire suppression.

### CROSS-REFERENCE

This application claims the benefit of U.S. Provisional Application No. 63/245,689, filed Sep. 17, 2021, which is hereby incorporated by reference in its entirety herein.

### BACKGROUND

Every year millions of acres of land are destroyed due to wildfires. In two of the past five years, wildfire destruction surpassed 10 million acres. Some years have seen the loss of over 40 million acres. Wildfire related loss of homes, farms, vehicles, animal and human life have all increased recently, due to drought, pest infestation, and climatic change.

### SUMMARY

While many current fire extinguishing means exist, many lack the ability to efficiently extinguish large number of bush fires. The low exit velocities and high flow rates of current devices requires large volumes of dispersing agents, which limits portability. As such, the devices and systems herein propel smaller volumes of dispersing agents at higher speeds to more efficiently extinguish fires.

One aspect provided herein is a portable fire extinguishing system comprising: a dispersing agent tank having a first inner surface comprising a fill port; a pipe fitting fluidically coupled to the fill port, wherein a first termination of the pipe fitting is generally parallel to and offset from the first inner surface; a pressurizer fluidically coupled with a second termination of the fitting; and a fill hose fluidically coupled with a third termination of the fitting.

In some embodiments, the system further comprises a one-way check valve fluidically coupling the fill hose to the third termination of the pipe fitting. In some embodiments, the system further comprises a quick disconnect fluidically coupling the one-way check valve to the fill hose. In some embodiments, the system further comprises a quick disconnect fitting fluidically coupling the one-way check valve to the fill hose. In some embodiments, the system further comprises a feed hose fluidically coupling the pressurizer to the second termination of the pipe fitting. In some embodiments, the system further comprises a quick disconnect fitting fluidically coupling the feed hose to the pressurizer. In some embodiments, the pipe fitting further comprises a fourth termination that is generally parallel to and offset from the first inner surface. In some embodiments, the fill hose terminates in a female garden hose threaded coupling. In some embodiments, the dispersing agent tank further comprises: a waste belt; a backpack strap; a removable cap; or any combination thereof.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a first illustration of an exemplary portable fire extinguishing system; per one or more embodiments herein;

FIG. 2 shows a second illustration of an exemplary portable fire extinguishing system; per one or more embodiments herein;

FIG. 3 shows a first image of an exemplary portable fire extinguishing system; per one or more embodiments herein;

FIG. 4 shows a first image of an exemplary portable fire extinguishing system; per one or more embodiments herein;

FIG. 5 shows an image of a pipe fitting, fill hose, and feed hose of an exemplary portable fire extinguishing system; per one or more embodiments herein; and

FIG. 6 shows an image of a pipe fitting of an exemplary portable fire extinguishing system; per one or more embodiments herein.

### DETAILED DESCRIPTION

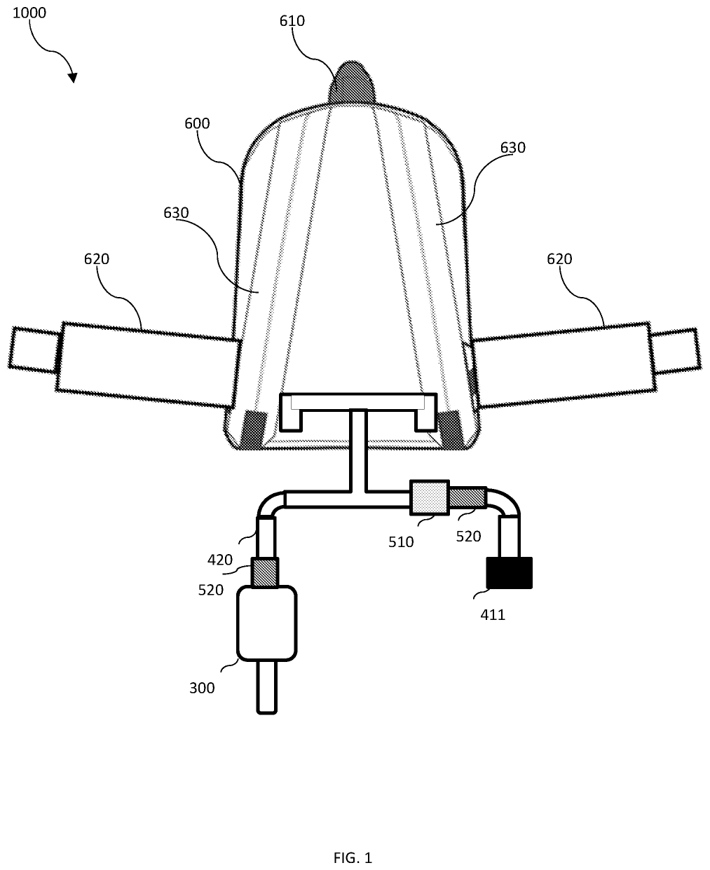

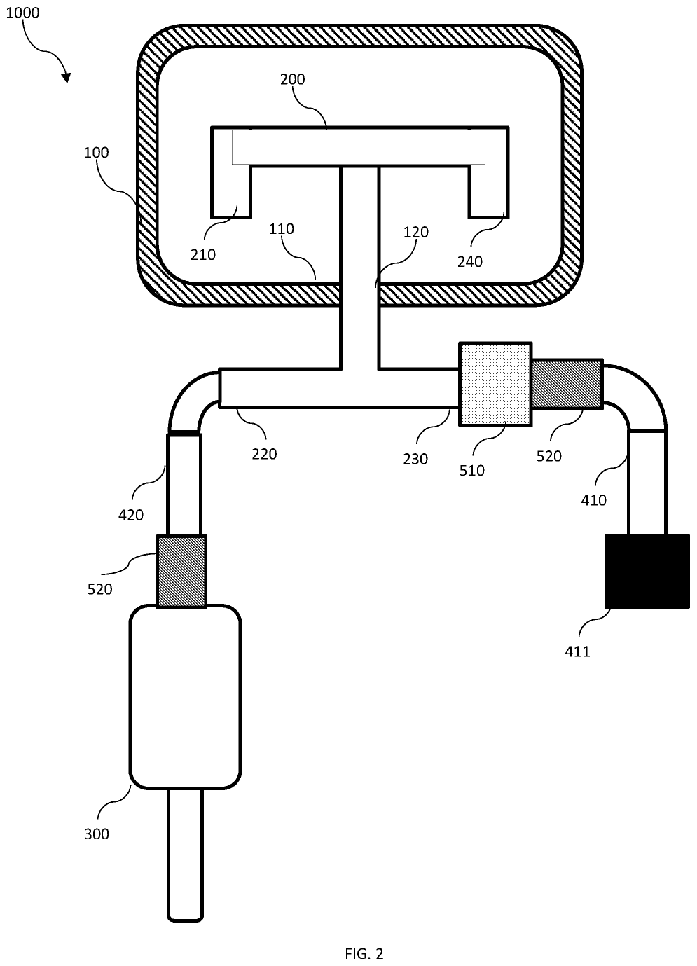

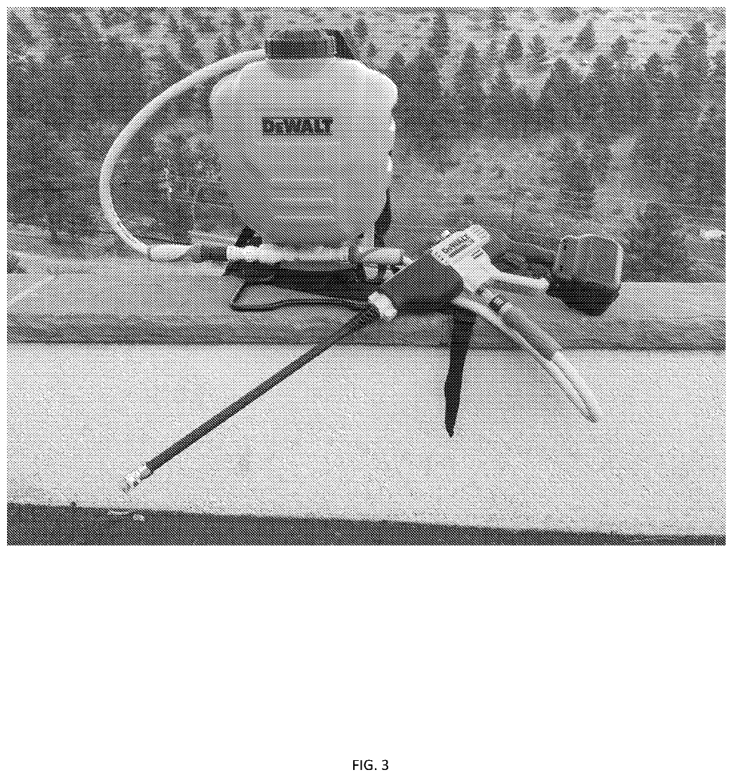

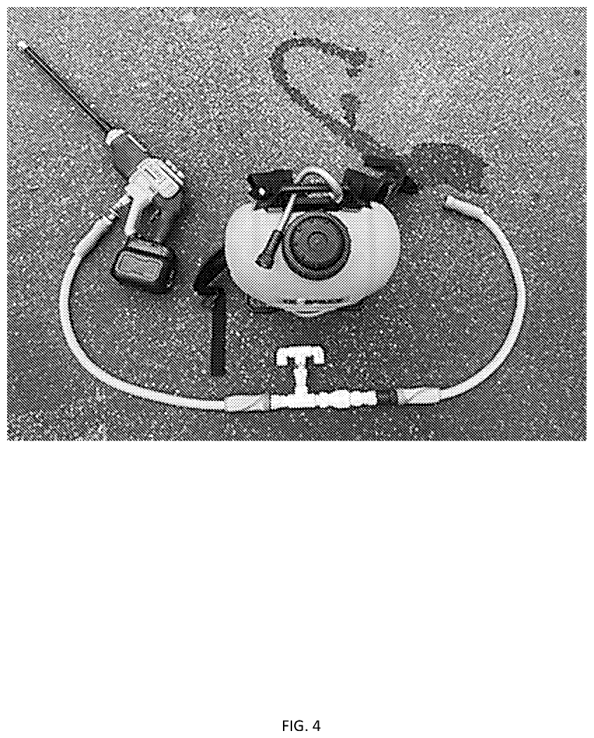

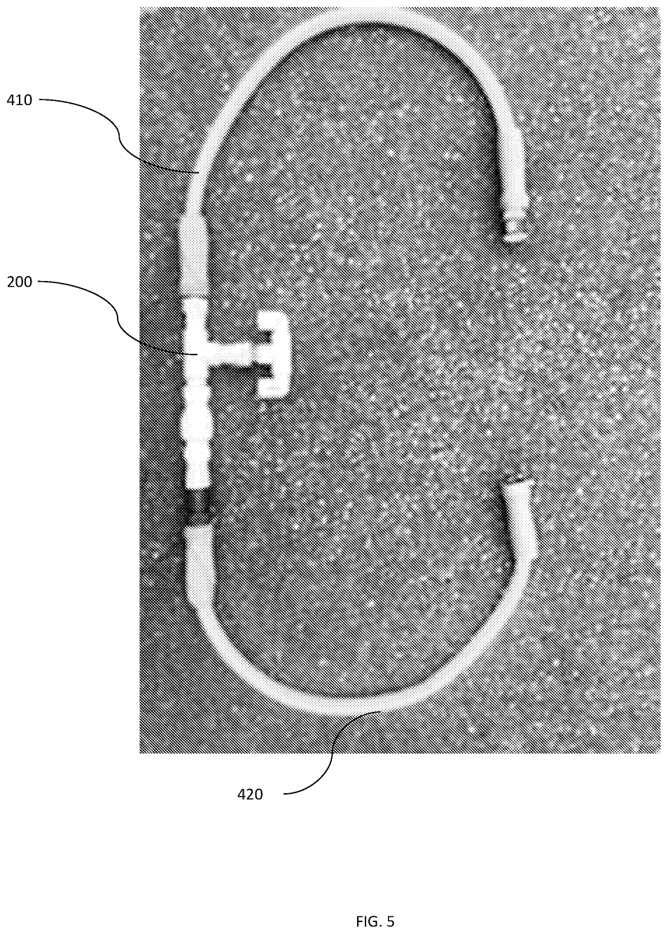

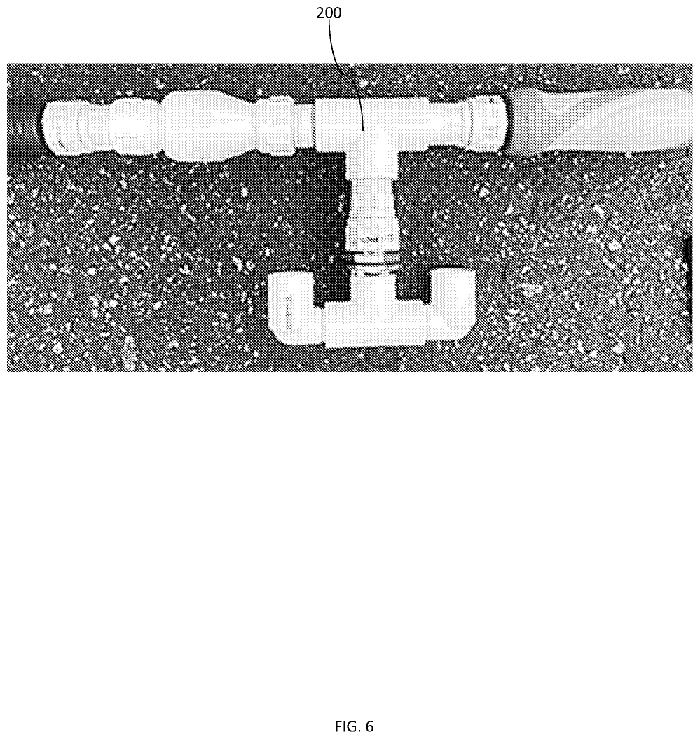

Provided herein, per FIGS. 1-6, is an exemplary portable fire extinguishing system 1,000. As shown in FIG. 2, the exemplary portable fire extinguishing system 1,000 comprises a dispersing agent tank 100, a pipe fitting 200, a pressurizer 300, and a fill hose 410.

In some embodiments, the dispersing agent tank 100 has a first inner surface 110. In some embodiments, the first inner surface 110 comprises a fill port 120. In some embodiments, the dispersing agent tank 100 further comprises a backpack 600. In some embodiments, the backpack 600 comprises a waste belt 620, a backpack strap 630. a removable cap 610, or any combination thereof. In some embodiments, the dispersing agent tank 100 is configured to contain a dispersing agent. In some embodiments, the dispersing agent comprises a surfactant.

In some embodiments, the pipe fitting 200 is fluidically coupled to the fill port 120. In some embodiments, a first termination 210 of the pipe fitting 200 is generally parallel to and offset from the first inner surface 110. In some embodiments, the pipe fitting 200 further comprises a fourth termination 240 that is generally parallel to and offset from the first inner surface 110. In some embodiments, the offset prevents foaming of the dispersing agent as it enters the dispersing agent tank 100.

In some embodiments, the pressurizer 300 is fluidically coupled with a second termination 220 of the fitting. In some embodiments, the pressurizer 300 comprises a battery for portable able use. In some embodiments, the pressurizer 300 comprises a charging cable to power the battery. In some embodiments, the pressurizer 300 is a pressure washer. In some embodiments, the pressurizer 300 is configured to eject a fluid from the dispersing tank 100 at a rate of about 10 ml/min, 20 ml/min, 30 ml/min, 40 ml/min, 50 ml/min, 75 ml/min, 100 ml/min, 150 ml/min, 200 ml/min, 250 ml/min, 300 ml/min, 350 ml/min, 500 ml/min, 600 ml/min, 700 ml/min, 800 ml/min, 900 ml/min, or 1,000 ml/min. In some embodiments, the pressurizer 300 is configured to eject a fluid from the dispersing tank 100 at a rate of at least about 10 ml/min, 20 ml/min, 30 ml/min, 40 ml/min, 50 ml/min, 75 ml/min, 100 ml/min, 150 ml/min, 200 ml/min, 250 ml/min, 300 ml/min, 350 ml/min, 500 ml/min, 600 ml/min, 700 ml/min, 800 ml/min, 900 ml/min, 1,000 ml/min or more including increments therein. In some embodiments, the pressurizer 300 is configured to eject a fluid from the dispersing tank 100 at a rate of at most about 10 ml/min, 20 ml/min, 30 ml/min, 40 ml/min, 50 ml/min, 75 ml/min, 100 ml/min, 150 ml/min, 200 ml/min, 250 ml/min, 300 ml/min, 350 ml/min, 500 ml/min, 600 ml/min, 700 ml/min, 800 ml/min, 900 ml/min, or 1,000 ml/min.

In some embodiments, the fill hose 410 fluidically coupled with a third termination 230 of the fitting. In some embodiments, the fill hose 410 terminates in a female garden hose threaded coupling 411.

In some embodiments, the system 1,000 further comprises a one-way check valve 510 fluidically coupling the fill hose 410 to the third termination 230 of the pipe fitting 200. In some embodiments, the system 1,000 further comprises a quick disconnect 520 fluidically coupling the one-way check valve 510 to the fill hose 410. In some embodiments, the system 1,000 further comprises a quick disconnect 520 fitting fluidically coupling the one-way check valve 510 to the fill hose 410. In some embodiments, the system 1,000 further comprises a feed hose 420 fluidically coupling the pressurizer 300 to the second termination 220 of the pipe fitting 200. In some embodiments, the system 1,000 further comprises a quick disconnect 520 fitting fluidically coupling the feed hose to the pressurizer 300.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A portable fire extinguishing system comprising:
(a) a dispersing agent tank having a first inner surface comprising a fill port;
(b) a pipe fitting fluidically coupled to the fill port, wherein a first termination of the pipe fitting is generally parallel to and offset from the first inner surface;
(c) a pressurizer fluidically coupled with a second termination of the fitting; and
(d) a fill hose fluidically coupled with a third termination of the fitting.

2. The system of claim 1, further comprising a one-way check valve fluidically coupling the fill hose to the third termination of the pipe fitting.

3. The system of claim 2, further comprising a quick disconnect fluidically coupling the one way check valve to the fill hose.

4. The system of claim 1, further comprising a quick disconnect fitting fluidically coupling the one-way check valve to the fill hose.

5. The system of claim 1, further comprising a feed hose fluidically coupling the pressurizer to the second termination of the pipe fitting.

6. The system of claim 5, further comprising a quick disconnect fitting fluidically coupling the feed hose to the pressurizer.

7. The system of claim 1, wherein the pipe fitting further comprises a fourth termination that is generally parallel to and offset from the first inner surface.

8. The system of claim 1, wherein the fill hose terminates in a female garden hose threaded coupling.

9. The system of claim 1, wherein the dispersing agent tank further comprises:
(a) a waste belt;
(b) a backpack strap;
(c) a removable cap; or
(d) any combination thereof.
